(19) United States
(12) Patent Application Publication
(10) Pub. No.: US 2009/0122128 A1
(43) Pub. Date: May 14, 2009

(54) TACHOGRAPH FOR A MOTOR VEHICLE, PAPER STRIP FOR A TACHOGRAPH AND METHOD FOR ALIGNING A LONGITUDINALLY DISPLACEABLE PAPER STRIP WITH RESPECT TO A PRINTING DEVICE IN A TACHOGRAPH

(76) Inventors: Klaus Hug, Oberndorf (DE); Herbert Kirner, Villingen-Schwenningen (DE); Benjamin Sager, Villingen-Schwenningen (DE); Harald Trampert, Villingen-Schwenningen (DE); Torsten Wahler, Bad Durrheim (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/300,900

(22) PCT Filed: May 10, 2007
(86) PCT No.: PCT/EP2007/054512

§ 371 Date: Nov. 14, 2008

(30) Foreign Application Priority Data
May 22, 2006 (DE) 10 2006 023 984.9

(51) Int. Cl. B41J 2/00

(52) U.S. Cl. 347/188

(57) ABSTRACT

A paper strip (6) for a tachograph (1) has a series of marks (17, 18) which extend transversely with respect to its direction of movement in the tachograph (1). The marks (17, 18) are of different lengths and are sensed by a sensor (10, 11). The sensor (10, 11) generates a signal sequence which provides definitive information about an offset of the paper strip (6) in the printing unit (7). A control device (12) actuates a printing unit (7) of the tachograph (1) and compensates for the offset.

### CROSS-REFERENCE TO RELATED APPLICATIONS

This application is a U.S. National Stage Application of International Application No. PCT/EP2007/054512 filed May 10, 2007, which designates the United States of America, and claims priority to German Application No. 10 2006 023 984.9 filed May 22, 2006, the contents of which are hereby incorporated by reference in their entirety.

### TECHNICAL FIELD

The invention relates to a tachograph for a motor vehicle, with a receptacle for a paper strip, with a printing unit for issuing data in precisely designated positions in relation to a reference line of a region to be printed, which reference line extends longitudinally over the paper strip in the designated direction of movement, with a driving device for driving the paper strip, and with an electronic control device for actuating the printing unit and the driving device. The invention furthermore relates to a paper strip for a tachograph, with a region which is to be printed and with a reference line extending longitudinally over the paper strip. The invention furthermore relates to a method for aligning a longitudinally displaceable paper strip with respect to a printing device in a tachograph, in which the printing device is aligned with respect to a reference line of a region to be printed, which reference line extends longitudinally over the paper strip.

### BACKGROUND

Known typing devices for issuing data stored in a tachograph generally have a pin-feed platen, the pins of which penetrate edge perforations of the paper strip and ensure the feeding of the paper strip under the printing unit. The paper strip is generally coiled up on a paper reel. The edge perforation of the paper strip serves to align the printing unit in relation to the region which is to be printed and on which a grid network is generally arranged. In addition, the edge perforation reduces the slippage during the driving of the paper strip. When a new paper reel is inserted, the printing unit is adjusted to a reference position with respect to the region to be printed. The adjustment is intended to ensure that the data, for example a graphical depiction of the driving speed of the motor vehicle, are transmitted over time in the designated positions on the grid network.

However, a drawback of the known tachograph and of the known paper reel is that tolerances may occur between the printing unit and the visible grid network of the region of the paper reel that is to be printed, and therefore the position of the data with respect to the visible grid network is not reliably ensured. Such tolerances may lie in the components of the tachograph itself, for example because of an inclination of the pin-feed platen, or in the position of the printing unit. Furthermore, tolerances may occur due to geometrical fluctuations in the paper dimensions or in the optically visible grid network. Furthermore, such tolerances may also occur due to the paper strip absorbing moisture during operation of the tachograph.

### SUMMARY

A tachograph of the type mentioned at the beginning can be designed in such a manner that a reliable alignment of the printing unit with respect to the reference line of the region to be printed is ensured. Furthermore, a paper strip can be provided for a tachograph of this type, said paper strip ensuring reliable alignment in the tachograph with respect to the reference line of the region to be printed. Furthermore, a method for aligning the paper strip with respect to the printing unit of the tachograph can be provided, said method permitting a reliable assignment of the data printed out from the tachograph with respect to the reference line of the paper strip.

According to an embodiment, a tachograph for a motor vehicle, may comprise a receptacle for a paper strip, a printing unit for issuing data in precisely designated positions in relation to a reference line of a region to be printed, which reference line extends longitudinally over the paper strip in the designated direction of movement, a driving device for driving the paper strip, and an electronic control device for actuating the printing unit and the driving device, wherein a sensor is connected to the control device, the sensor is designed for sensing a series of marks which extend to different distances transversely with respect to the reference line and for generating signal sequences corresponding to the sensed marks, and wherein the control device is designed for actuating the position of the printout of the printing unit transversely with respect to the reference line of the paper strip as a function of the signal sequence of the sensor.

According to a further embodiment, the sensor may be arranged on a side of a paper guide of the paper strip, which side lies opposite the printing unit. According to a further embodiment, a respective sensor for sensing marks of the paper strip can be arranged on both longitudinal sides of the paper strip, and wherein the control device is designed for determining a width extent of the paper strip as a function of the signal sequences of the sensors. According to a further embodiment, the sensor can be operable to detect optical, magnetic, inductive or electric marks. According to a further embodiment, the sensor may have a laser and may be operable to detect reflections of the laser.

According to another embodiment, a paper strip for a tachograph, may comprise a region which is to be printed and a reference line extending longitudinally over the paper strip, wherein marks provided for sensing by the sensor of the tachograph are arranged in a designated position with respect to the reference line and extend to different distances transversely with respect to a designated direction of movement.

According to a further embodiment, the marks can be arranged periodically with respect to one another and are of different lengths. According to a further embodiment, the marks can be arranged on the rear side of the region to be printed. According to a further embodiment, the marks can be arranged on two longitudinal sides of the paper strip.

According to another embodiment, a method for aligning a longitudinally displaceable paper strip with respect to a printing unit in a tachograph, may comprise the steps of: aligning the printing unit with respect to a reference line of a region to be printed, which reference line extends longitudinally over the paper strip, and sensing a series of marks which are arranged on the paper strip transversely with respect to the direction of movement and are of different lengths by a sensor, wherein a control device detects an offset of the printing unit with respect to the reference line from the signal sequence of the sensor and actuates the printing unit in order to compensate for the offset.

According to a further embodiment, a line can be printed out during a first adjustment of the printing unit of the tachograph with respect to the reference line of the paper strip, in that an offset of the line with respect to the reference line is measured and is input into the control device, and in that the control device compensates for the measured offset during the actuation of the printing unit.

### BRIEF DESCRIPTION OF THE DRAWINGS

The invention permits numerous embodiments. To further clarify its basic principle, one of these is illustrated in the drawing and is described below. In the drawing

FIG. 1 shows a longitudinal section through a tachograph according to an embodiment,

FIG. 2 shows a front side of a paper strip of a paper reel for the tachograph from FIG. 1,

FIG. 3 shows a rear side of the paper strip from FIG. 2 with sensors of the tachograph from FIG. 1,

FIG. 4 shows, on a greatly enlarged scale, a series of marks arranged on the rear side of the paper strip,

FIGS. 5a, 5b show two diagrams of signal sequences of a sensor sensing the series of marks in different positions.

### DETAILED DESCRIPTION

According to an embodiment, the sensor can be designed for sensing a series of marks which extend to different distances transversely with respect to the reference line and for generating signal sequences corresponding to the sensed marks, and in that the control device is designed for actuating the position of the printout of the printing unit transversely with respect to the reference line of the paper strip as a function of the signal sequence of the sensor.

This design enables the control device to align the printing unit using the signal sequence of the sensor. Since the signal sequence of the sensor is dependent on the marks detected, and the marks detected extend to different distances transversely with respect to the reference line and therefore with respect to the direction of movement of the paper strip, different numbers of marks are sensed as a function of the position of the paper strip with respect to the sensor. This results in a signal sequence corresponding to the position of the paper strip with respect to the printing unit. The printing unit can therefore be aligned particularly reliably with respect to the reference line of that region of the paper strip which is to be printed, and can preferably keep a curved profile, which is to be printed out by the printing unit, of the printout continuously at the designated alignment with respect to the reference line.

Restriction of the freedom of movement of the printing unit over the region to be printed because of the sensor can be avoided in a simple manner, according to another embodiment, if the sensor is arranged on a side of a paper guide of the paper strip, which side lies opposite the printing unit. By this means, one side of the paper strip is provided exclusively for issuing the data while the other side can have the marks for the sensor.

Swelling of the paper strip, for example due to absorption of moisture, may result in an enlargement of the region to be printed. This results in an erroneous issuing of the data in the event of a grid network being arranged on that region of the paper strip which is to be printed. According to an embodiment, swelling of the paper strip can be taken into consideration in a simple manner during the issuing of the data if a respective sensor for sensing marks of the paper strip is arranged on both longitudinal sides of the paper strip, and if the control device is designed for determining a width extent of the paper strip as a function of the signal sequences of the sensors. In this case, the control device can prepare a graphic, which is to be printed out, in such a manner that, if the paper strip becomes wider, the graphic which is to be printed out is stretched or, if the paper width becomes smaller, is compressed.

The tachograph according to an embodiment turns out to be particularly simple structurally if the sensor is designed for detecting optical, magnetic, inductive or electric marks.

The sensor could have, for example, a cost-effective reflex light barrier. However, according to another embodiment, the sensor has particularly high resolution if the sensor has a laser and is designed for detecting reflections of the laser. By this means, the accuracy of the alignment of the printing unit with respect to the paper strip is further increased.

The problem mentioned second, namely the provision of a paper strip for such a tachograph, the paper strip ensuring reliable alignment in the tachograph with respect to the reference line of the region to be printed, is solved according to an embodiment in that marks provided for sensing by the sensor of the tachograph are arranged in a designated position with respect to the reference line and extend to different distances transversely with respect to a designated direction of movement.

By means of this design, the marks are arranged on the paper strip and, by means of the sensing of the sensor arranged in the tachograph, permit a reliable alignment of the reference line with respect to the printing unit.

The data to be issued can therefore be plotted onto the region to be printed in a particularly reliable manner with respect to the reference line.

According to an embodiment, the marks are constructed in a particularly simple manner if the marks are arranged periodically with respect to one another and are of different lengths.

Disturbance of the transmitted data by the marks can be avoided in a simple manner, according to an embodiment, if the marks are arranged on the rear side of the region to be printed.

Swelling of the paper strip, for example due to effects of moisture, can be detected in a simple manner by means of two sensors arranged in the tachograph if the marks are arranged on two longitudinal sides of the paper strip.

The problem mentioned third, namely the provision of a method for aligning the paper strip with respect to the printing unit of the tachograph, the method permitting reliable assignment of the data printed out from the tachograph with respect to the reference line of the paper strip, is solved according to an embodiment in that a series of marks which are arranged on the paper strip transversely with respect to the direction of movement and are of different lengths is sensed by a sensor, in that a control device detects an offset of the printing unit with respect to the reference line from the signal sequence of the sensor and actuates the printing unit in order to compensate for the offset.

By means of this design, the position of the paper strip is determined using the signal sequence of the sensor, and, using the signal sequence, the printing unit is actuated and aligned over the reference line. By this means, tolerances between the printing unit and the reference line are compensated for and therefore a reliable assignment of the data printed out from the tachograph with respect to the reference line is ensured. In this case, the alignment of the printing unit in accordance with the signal sequence of the sensor can take place continuously or at short cyclical time intervals. A curved profile, which is to be printed out by the printing unit, of the printout can therefore preferably be kept continuously at the designated alignment with respect to the reference line.

According to another embodiment, manufacturing tolerances of the printing unit can be compensated for in a simple manner if a line is printed out during a first adjustment of the printing unit of the tachograph with respect to the reference line of the paper strip, if an offset of the line with respect to the reference line is measured and is input into the control device, and if the control device compensates for the measured offset during the actuation of the printing unit. In the simplest case, the control device adds the offset measured during the first adjustment to the offset determined during operation of the tachograph.

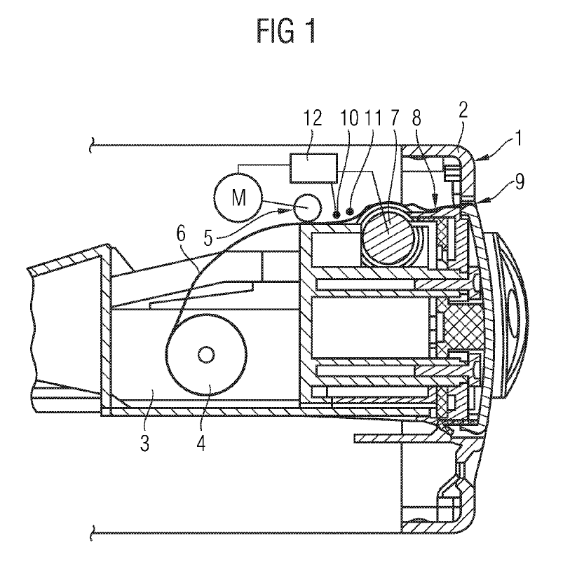

FIG. 1 shows, schematically in a longitudinal section, a tachograph 1 for a motor vehicle, with a front panel 2. The tachograph 1 has a magazine 3 with a paper reel 4 and a motorized driving device 5 for transporting a paper strip 6 wound on the paper reel 4. The tachograph 1 furthermore has a printing unit 7 for printing the paper strip 6 of the paper reel 4. In order to simplify the drawing, of the printing unit 7 only a printing roller is illustrated. The paper strip 6 of the paper reel 4 is guided from the magazine 3 in a paper guide 8 over the printing unit 7 to a gap 9 in the front panel 2. The paper strip 6 printed by the printing unit 7 is issued through the gap 9 in the front panel 2 and can be torn off. Sensors 10, 11 for detecting the position and the width of the paper strip 6 in the paper guide 8 are also arranged on the paper guide 8. The sensors 10, 11 are arranged consecutively, as illustrated in FIG. 3. The sensors 10, 11, the motorized driving device 5 and the printing unit 7 are connected to an electronic control device 12. The control device 12 actuates the printing unit 7 and the driving device 5 as a function of the signals of the sensors 10, 11. This enables the position of the printing unit 7 to be aligned with respect to the position of the paper strip 6.

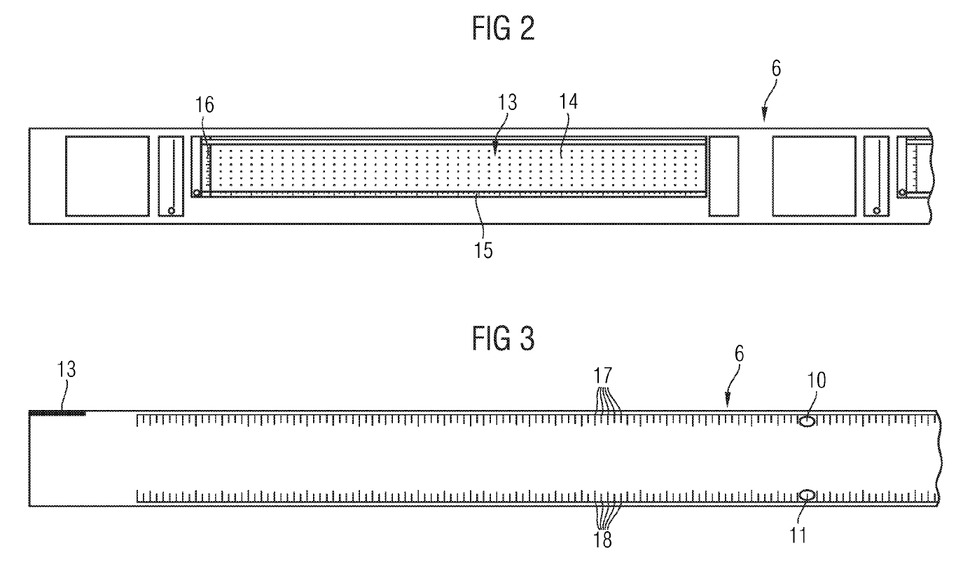

FIG. 2 shows a partial region of the paper strip 6 of the paper reel 4 from FIG. 1 with a region 13 which is to be printed by the printing unit 7. The region 13 which is to be printed has a visible grid network 14, which is designed in the form of a grid, and a reference line 15 extending in the longitudinal direction of the paper strip. In addition, the printable region is delimited by a scale 16 arranged transversely with respect to the reference line 15. The reference line 15 can be provided, for example, with a time axis while the scale 16 indicates the driving speed of the motor vehicle. The direction of movement of the paper strip 6 in the tachograph 1 takes place in the direction of the reference line 15.

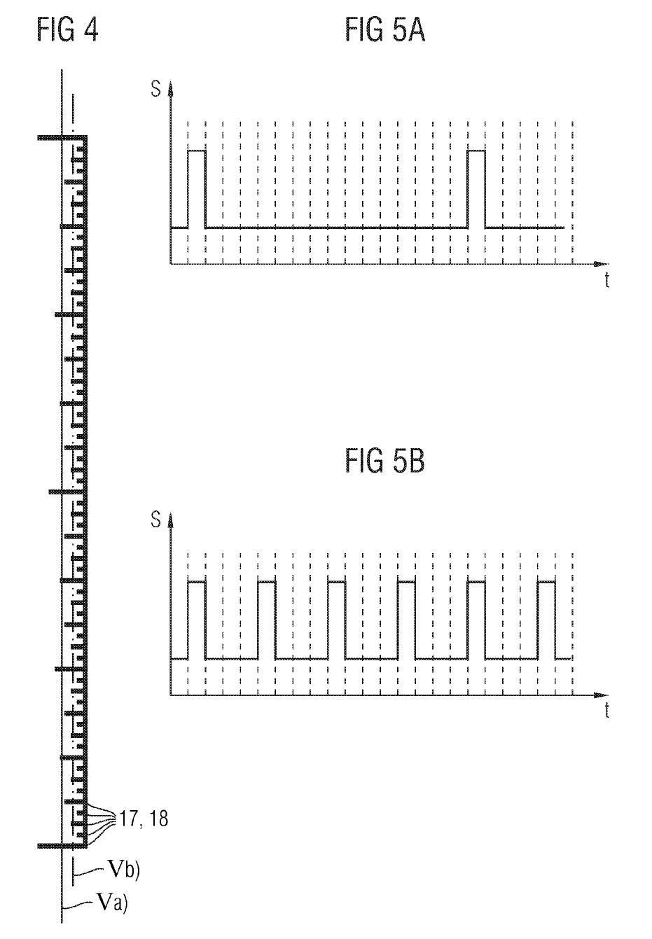

FIG. 3 shows a rear side of the paper strip 6 from FIG. 2 and, schematically, the sensors 10, 11 of the tachograph from FIG. 1. On the rear side of the paper strip 6, a respective series of marks 17, 18 detected by the sensors 10, 11 are arranged on both longitudinal sides. It can be seen in this case that the marks 17, 18 are arranged transversely with respect to the longitudinal direction of the paper strip 6. It is essential for the marks 17, 18 that they are arranged in a reference line with a high degree of accuracy with respect to the front side, which is illustrated in FIG. 2. The shape of the marks 17, 18 is illustrated on a greatly enlarged scale in FIG. 4. A visible color mark 19 which indicates the near end of the paper reel 4 is arranged at the end of the paper strip 6.

FIG. 4 shows, on a greatly enlarged scale, one of the series of marks 17, 18 from FIG. 3. It can be seen in this case that the marks 17, 18 are designed to be of different lengths and extend to different distances transversely with respect to the longitudinal direction of the paper strip 6.

Two possible positions of the sensors 10, 11 over the marks 17, 18 are arranged at Va and Vb. FIG. 5a represents a signal sequence S of the sensors 10, 11 over the time t, which signal sequence is supplied by the corresponding sensor 10, 11 when it is located in position Va over the series of marks 17, 18 and the driving device 5 drives the paper strip 6. By contrast, FIG. 5b shows the signal sequence S over the time t, which signal sequence is supplied by the corresponding sensor 10, 11 when it is in position Vb over the marks 17, 18.

During operation of the tachograph 1 for the first time, with the first adjustment of the printing unit 7 on the paper strip 6 a line is printed out and the signal sequence of the sensors 10, 11 measured. For example, the signal sequence illustrated in FIG. 5a is produced during the measurement. Furthermore, the offset of the line with respect to the reference line 15 is measured and the printing unit 7 is adjusted via the control device 12 or manually in such a manner that, during a following printout, the line is printed, for example, directly on the reference line 15. The printing unit 7 is therefore adjusted with respect to the region 13 to be printed. If, during operation or after the paper reel 4 has been changed, the sensors 10, 11 generate a different signal sequence, for example the signal sequence illustrated in FIG. 5b, the offset of the paper strip 6 in relation to the printing unit 7 can be determined in the control device 12 as a function of the dimensions of the marks 17, 18. The control device 12 subsequently actuates the printing unit 7 in such a manner that the offset is compensated for. The printout by the printing unit 7 therefore takes place in a manner offset by the offset determined in relation to the printout after the first adjustment. The second series of marks 17, 18 illustrated in FIG. 3 serves to detect the width of the paper strip 6. Since the width of the paper strip 6 can vary, for example as a function of the moisture, a stretched printout takes place by the printing unit 7 in the event of the paper strip 6 becoming wider and a compressed printout in the event of the paper strip 6 becoming smaller.

What is claimed is:

1. A tachograph for a motor vehicle, comprising a receptacle for a paper strip, printing unit for issuing data in precisely designated positions in relation to a reference line of a region to be printed, which reference line extends longitudinally over the paper strip in the designated direction of movement, a driving device for driving the paper strip, and an electronic control device for actuating the printing unit and the driving device, wherein a sensor is connected to the control device, the sensor is designed for sensing a series of marks which extend to different distances transversely with respect to the reference line and for generating signal sequences corresponding to the sensed marks, and wherein the control device is designed for actuating the position of the printout of the printing unit transversely with respect to the reference line of the paper strip as a function of the signal sequence of the sensor.

2. The tachograph according to claim 1, wherein the sensor is arranged on a side of a paper guide of the paper strip, which side lies opposite the printing unit.

3. The tachograph according to claim 1, wherein a respective sensor for sensing marks of the paper strip is arranged on both longitudinal sides of the paper strip, and wherein the control device is designed for determining a width extent of the paper strip as a function of the signal sequences of the sensors.

4. The tachograph according to claim 1, wherein the sensor is operable to detect optical, magnetic, inductive or electric marks.

5. The tachograph according to claim 1, wherein the sensor has a laser and is operable to detect reflections of the laser.

6. A paper strip for a tachograph, comprising a region which is to be printed and a reference line extending longitudinally over the paper strip, wherein marks provided for sensing by the sensor of the tachograph are arranged in a designated position with respect to the reference line and extend to different distances transversely with respect to a designated direction of movement.

7. The paper strip according to claim 6, wherein the marks are arranged periodically with respect to one another and are of different lengths.

8. The paper strip according to claim 6, wherein the marks are arranged on the rear side of the region to be printed.

9. The paper strip according to claim 6, wherein the marks are arranged on two longitudinal sides of the paper strip.

10. A method for aligning a longitudinally displaceable paper strip with respect to a printing unit in a tachograph, comprising the steps of: aligning the printing unit with respect to a reference line of a region to be printed, which reference line extends longitudinally over the paper strip, and sensing a series of marks which are arranged on the paper strip transversely with respect to the direction of movement and are of different lengths by a sensor, wherein a control device detects an offset of the printing unit with respect to the reference line from the signal sequence of the sensor and actuates the printing unit in order to compensate for the offset.

11. The method according to claim 10, wherein a line is printed out during a first adjustment of the printing unit of the tachograph with respect to the reference line of the paper strip, in that an offset of the line with respect to the reference line is measured and is input into the control device, and in that the control device compensates for the measured offset during the actuation of the printing unit.
